(19) United States
(12) Patent Application Publication
(10) Pub. No.: US 2026/0264584 A1
(43) Pub. Date: Sep. 10, 2026

(54) CHILD SAFETY SEAT FOR CARS

(71) Applicant: NINGBO YUANYUAN AUTO ACCESSORIES CO., LTD, Cixi City (CN)

(72) Inventor: Xijiong FU, Cixi City (CN)

(21) Appl. No.: 19/322,561

(22) Filed: Sep. 8, 2025

(30) Foreign Application Priority Data
Mar. 6, 2025 (CN) 202510261895.2

(51) Int. Cl. B60N 2/28

(52) U.S. Cl. CPC B60N 2/2821; B60N 2/2869; B60N 2/2875

(57) ABSTRACT

A child safety seat comprises: a base unit; a seat unit movably disposed on the base unit, comprising a seat base and a seat back connected to the rear side of the seat base; a posture adjustment mechanism disposed between the seat unit and the base unit; and further comprising a bracket having a first connecting member and a second connecting member, a first sliding limiting mechanism being disposed between the second connecting member and the seat back, and a second sliding limiting mechanism being disposed between the base unit and the seat base. The second sliding limit mechanism replaces the bracket to bear the weight of the seat base, sharing the pressure exerted on the bracket by the seat unit, thereby reducing the pressure on the bracket and extending the service life of the bracket.

### TECHNICAL FIELD

The present invention relates to the technical field of child seats specifically suitable for use in vehicles.

### BACKGROUND

With improving living standards, more and more people are choosing to install child safety seats in their cars to ensure their children's safety. In daily use, due to the varying seating requirements and comfort requirements of children of different heights and weights, safety seats typically feature adjustable pitch angles. During pitch adjustment, the seat slides forward and backward relative to the base. Conventional child safety seats adjust the pitch angle of the safety seat by pulling the handle of the gear adjustment mechanism forward and upward to control the gear lever to engage different gear slots. However, when the gear lever is shifted between different gear slots, the forward and upward pull on the seat can cause the seat to rotate about the gear lever and tilt backward. If a child is in the seat during this period, the sudden backward tilt could cause the seat's head to collide with the seat, resulting in poor safety.

### SUMMARY OF THE INVENTION

The technical problem addressed by the present invention is to provide a child safety seat that stabilizes seat movement during pitch adjustment and prevents backward tilt.

The present invention solves the above-mentioned technical problem by adopting a technical solution: The child safety seat comprises: a base unit; a seat unit movably mounted on the base unit, comprising a seat base and a seat back connected to the rear side of the seat base; a posture adjustment mechanism disposed between the seat unit and the base unit for adjusting the pitch angle of the seat unit relative to the base unit; characterized in that the seat further comprises a bracket having a first connector connected to the base unit and a second connector connected to the rear side of the first connector and extending upwardly at an angle; a first sliding stopper mechanism disposed between the second connector and the seat back, and a second sliding stopper mechanism disposed between the base unit and the seat base; when the pitch angle of the seat unit relative to the base unit is adjusted using the posture adjustment mechanism, the first sliding stopper mechanism enables the seat back to slide relative to the second connector in a longitudinal direction of the seat back, and the second sliding stopper mechanism enables the seat base to slide on the base unit in a longitudinal direction of the seat base.

To facilitate user recline angle adjustment, the first sliding limiter mechanism further comprises: A guide rod disposed transversely on the second connecting member; Two sets of symmetrical, spaced-apart grooves disposed on the rear side of the seat backrest, with the lengths of the two sets of grooves perpendicular to the length of the guide rod. The ends of the guide rods extend into and slidably engage with the two sets of grooves, respectively. The sliding engagement between the two sets of grooves and the guide rods enables the seat backrest to slide back and forth along the length of the second connecting member.

The symmetrical arrangement of the grooves ensures that the guide rods on both sides of the second connecting member are of equal length during sliding, preventing the seat backrest from tipping over. This enhances safety for children and protects the guide rods. Furthermore, it enables the use of a single bracket to adjust the pitch angle of the seat unit.

To facilitate user tilt adjustment, the second sliding stop mechanism further comprises: Two sets of symmetrically spaced guide sliders mounted on the base unit. The seat base is provided with two symmetrically spaced sliding holes, distributed in an arcuate pattern along the fore-aft direction of the seat base. The two sets of guide sliders are respectively slidably and securely positioned within the two sets of sliding holes and slidably engage with them. The sliding engagement between the sliding holes in the seat base and the guide sliders mounted on the base unit prevents the bracket from bearing the weight of the seat base.

The weight of the seat base is applied to the symmetrically distributed guide sliders on the base unit, ensuring balanced forces on both sides of the seat base, preventing tilt. This stabilizes the seat base's center of gravity and further enhances the stability of the seat unit's pitch angle adjustment using a single bracket. To prevent the seat unit from separating from the base unit during pitch adjustment, the guide slider further comprises: A sliding pin extending vertically through the sliding hole and slidably engaging the inner wall of the hole; A stop block connected to the sliding pin. The stop block is wider than the width of the hole and abuts against the outside of the hole to limit upward movement of the seat unit relative to the base. When the seat unit slides relative to the base unit, the upper opening of the sliding hole abuts against the lower surface of the stop block, and the sliding pin slides along the wall of the sliding hole.

To ensure smoother movement of the slider within the sliding hole, the seat unit further includes a guide rail disposed at the upper opening of the sliding hole. The upper surface of the guide rail slidably engages with the lower surface of the stop block. The guide rail is provided with a first through-hole for the sliding pin to pass through, and the first through-hole communicates with the sliding hole. The sliding pin passes through the sliding hole and the first through-hole sequentially from bottom to top and is fixedly connected to the stop block at its upper end. When adjusting the tilt angle, the stop block can slide along the upper surface of the guide rail, assisting in sliding.

To further reduce the pressure on the bracket, the posture adjustment mechanism further comprises: Two sets of symmetrically spaced shift rails disposed on the base unit, each set of shift rails having shift slots spaced apart along the front-to-rear direction of the seat base. Correspondingly, a shift adjustment mechanism is connected to the seat base. The shift adjustment mechanism includes an actuating member for applying an external force and a shift lever that engages with the actuating member. The shift lever is disposed between the two sets of shift rails, with both ends of the shift lever engaging with the corresponding two sets of shift slots.

The shift lever can engage with and disengage from any corresponding set of shift slots. When the actuating member drives the shift lever out of the most corresponding shift slot, the seat unit can adjust its pitch angle relative to the base unit under the sliding cooperation of the first and second slide stop mechanisms. When the actuating member drives the shift lever into the most corresponding shift slot, the pitch angle of the seat unit relative to the base unit is locked.

The shift rails on the base unit ensure that the weight of the seat unit is supported by the shift rails rather than being applied directly to the brackets. To enhance the stability of the seat unit during pitch adjustment, the lower surface of the seat base is partially recessed to form a sliding portion. The sliding portion's surface matches the shape of the upper surface of the shift rails and can slide back and forth along the upper surface of the shift rails. The sliding engagement between the sliding portion and the shift rails provides a guide for sliding movement.

To enhance child comfort and enable adjustment of the seat unit to different orientations, the base unit further comprises a base, a rotating disk rotatably connected to the base, and a rotation limit assembly mounted on the base. The seat unit is mounted on the rotating disk, and the rotation limit assembly acts on the rotating disk to limit its rotational position. The rotating disk allows the seat unit to rotate relative to the base.

When adjusted to the appropriate angle, the rotation limit assembly locks the rotating disk in that position. To prevent the seat unit from tilting backward during rotation, the first connecting member is fixedly connected to the surface of the rotating disk, while the second connecting member is connected to the seat back to support it. Part or all of the second connecting member is embedded in the seat back to support it. The fixed connection of the first connecting member to the surface of the rotating disk allows the bracket to rotate synchronously with the rotating disk and the seat unit.

During rotation, the relative position of the bracket and the seat unit remains unchanged, ensuring that the second connecting member continuously supports the seat back during rotation. To prevent the rotating disk from separating from the base due to changes in the center of gravity of the seat unit during rotation, which could pose a risk, the base unit further includes an annular limit pressure ring fixedly connected to the base. The rotating disk is positioned between the limit pressure ring and the base, and the limit pressure ring has a limit portion that cooperates with the rotating disk to limit the axial position of the rotating disk.

The limit portion of the limit pressure ring limits the axial outward movement of the rotating disk. Compared with the prior art, the advantages of the present invention are as follows: 1. The child safety seat of the present invention utilizes a first sliding stop mechanism to allow the seat back to slide and stop relative to the second connector in the longitudinal direction of the seat back. The second sliding stop mechanism allows the seat base to slide and stop on the base unit in the fore-aft direction of the seat base. Consequently, both the seat back and the seat base can slide in their respective directions, preventing the seat unit from tilting backward during pitch adjustment. 2. The second sliding stop mechanism in the child safety seat of the present invention is located between the base and the seat base. This allows the second sliding stop mechanism to bear the weight of the seat base instead of the bracket, thereby relieving the pressure exerted by the seat unit on the bracket, thereby reducing the pressure on the bracket, protecting the bracket, and extending the bracket's service life. Furthermore, the design of the second sliding stop mechanism between the base and the seat base also reduces the required structural strength of the bracket, enabling manufacturers to use materials with lower structural strength to manufacture the bracket, thereby reducing the overall production cost of the safety seat and achieving the advantage of "one product for two purposes."

### BRIEF DESCRIPTION OF THE DRAWINGS

FIG. 1 is a schematic diagram of the structure of a child safety seat according to an embodiment of the present invention;

FIG. 2 is an exploded view of the structure of a child safety seat according to an embodiment of the present invention;

FIG. 3 is a cross-sectional view of a child safety seat according to an embodiment of the present invention;

FIG. 4 is a schematic diagram of the assembly relationship between the seat unit, bracket, and gear adjustment mechanism according to an embodiment of the present invention;

FIG. 5 is a rear view of the seat unit according to an embodiment of the present invention;

FIG. 6 is an exploded view of the structure of the posture adjustment mechanism according to an embodiment of the present invention;

FIG. 7 is a cross-sectional view of a child safety seat according to an embodiment of the present invention at another depth;

FIG. 8 is an exploded view of a portion of the structure of the base unit and seat unit according to an embodiment of the present invention;

FIG. 9 is a schematic diagram of the structure of the child safety seat according to an embodiment of the present invention.

FIG. 10 is a schematic diagram of the structure of a base unit according to an embodiment of the present invention;

FIG. 11 is a schematic diagram of the structure of a blocking plate according to an embodiment of the present invention;

FIG. 12 is an enlarged partial view of point A in FIG. 7;

FIG. 13 is an enlarged partial view of point B in FIG. 7;

FIG. 14 is an enlarged partial view of point C in FIG. 7;

FIG. 15 is a schematic diagram of the assembly relationship of the rotating disk, gear rail, and slider according to an embodiment of the present invention;

FIG. 16 is a schematic diagram of the structure of the rotation limit assembly according to an embodiment of the present invention;

FIG. 17 is a schematic diagram of the assembly relationship between the base unit and the bracket according to an embodiment of the present invention;

FIG. 18 is an enlarged partial view of the circled area in FIG. 17.

### DETAILED DESCRIPTION

The present invention will be described in further detail below with reference to the accompanying drawings and embodiments.

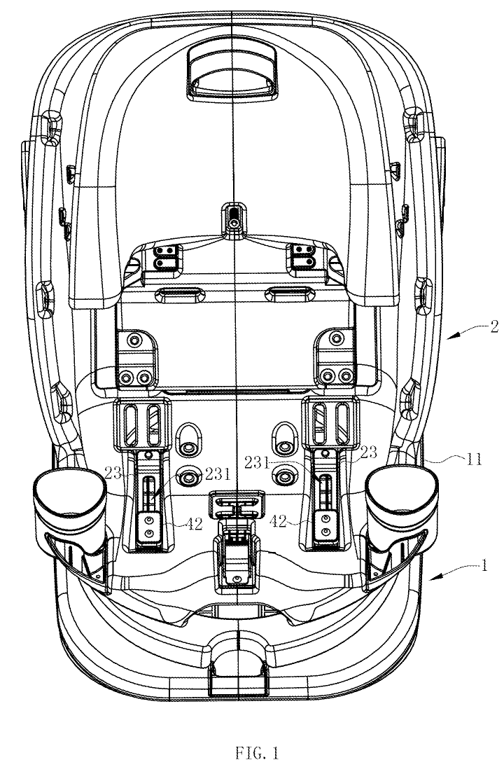

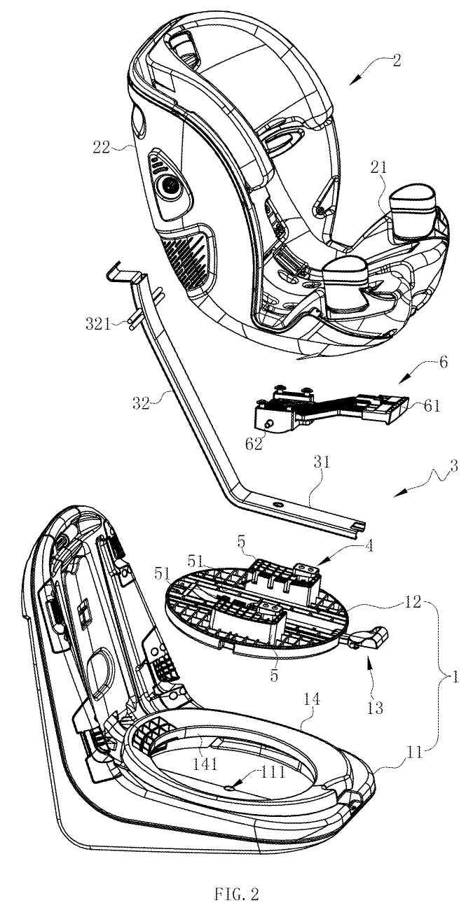

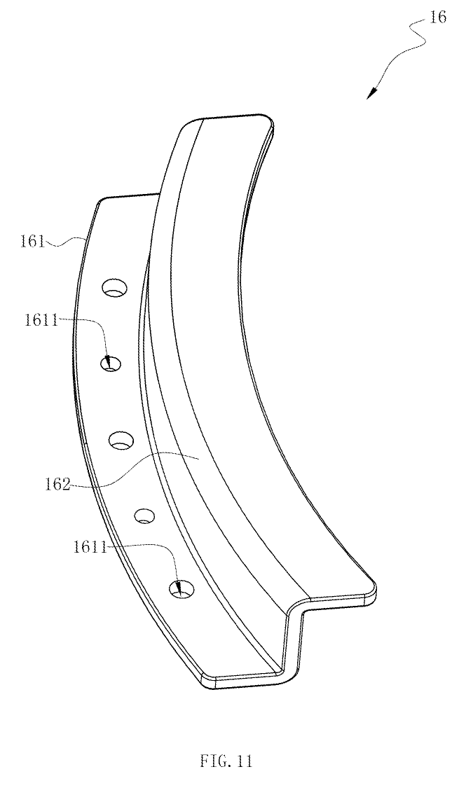

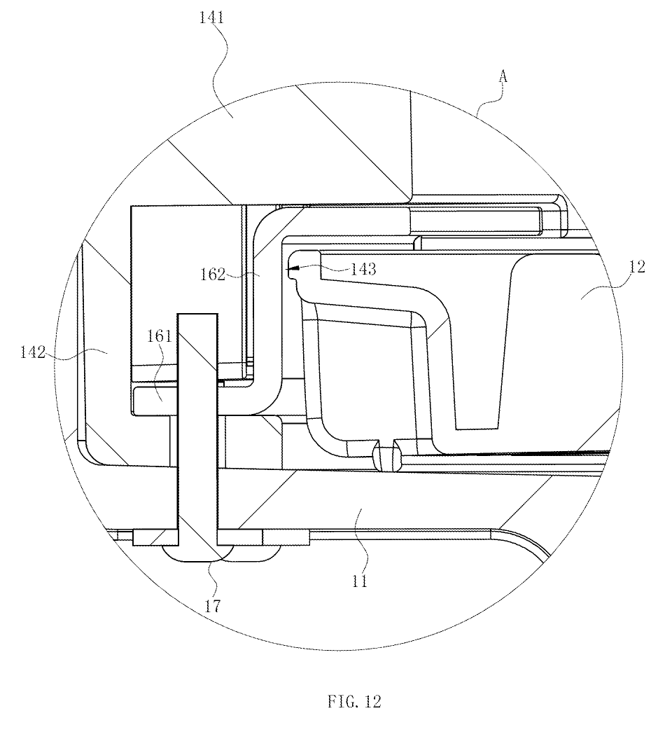

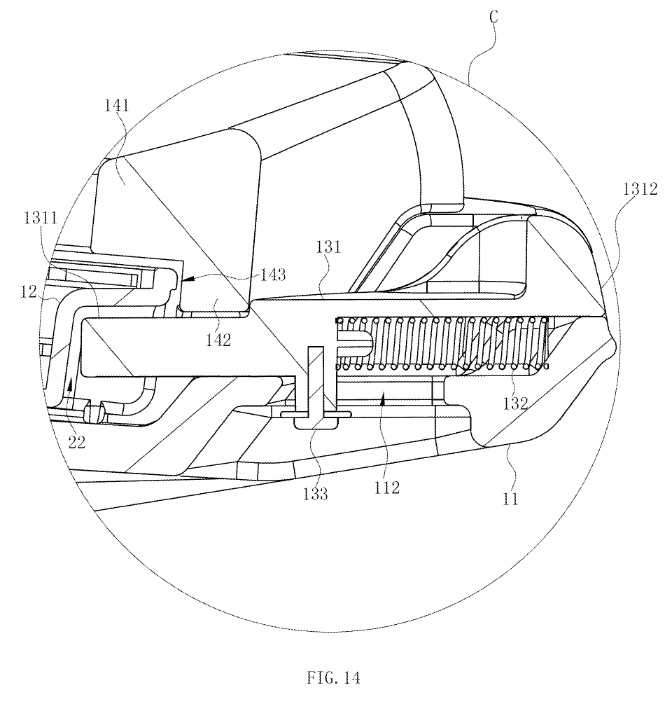

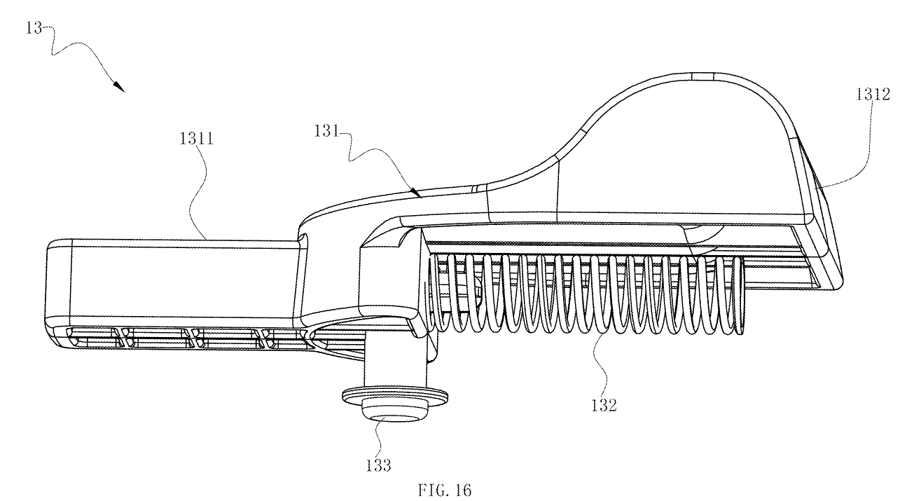

FIGS. 1 to 18 illustrate a preferred embodiment of the present invention. The child safety seat of this embodiment is primarily used to ensure the safety of children.

Currently, the seat unit of existing child safety seats is typically mounted on a base using two symmetrically arranged steel brackets. The seat's tilt, recline, and gear adjustment mechanisms all cooperate with the brackets, placing significant pressure on the brackets and causing fatigue after prolonged use.

Furthermore, the two steel brackets significantly increase the weight of the child safety seat, making installation more difficult for users. Therefore, it would be beneficial to provide a child safety seat with a bracket that has a reduced load-bearing capacity, a longer service life, and the ability to use lighter brackets. The detailed structure of this child safety seat is described below:

Referring to FIGS. 1 to 3 , the child safety seat of this embodiment includes a base unit 1, a seat unit 2 movably mounted on the base unit 1, an attitude adjustment mechanism disposed between the seat unit 2 and the base unit 1, and a bracket 3. The seat unit 2 includes a seat base 21 and a seat back 22 connected to the rear side of the seat base 21. The attitude adjustment mechanism is used to adjust the pitch angle of the seat unit 2 relative to the base unit 1. The bracket 3 has a plurality of cams and a plurality of cams. The base unit 1 includes a first connector 31 and a second connector 32 connected to the rear side of the first connector 31 and extending upwardly at an angle.

A first sliding stopper is provided between the second connector 32 and the seat back 22, and a second sliding stopper is provided between the base unit 1 and the seat base 21. When the pitch angle of the seat unit 2 relative to the base unit 1 is adjusted using the posture adjustment mechanism, the first sliding stopper allows the seat back 22 to slide relative to the second connector 32 in the longitudinal direction of the seat back 22, while the second sliding stopper allows the seat base 21 to slide along the front-to-back direction of the seat base 21 on the base unit 1.

The single-bracket structure of this child safety seat, with only one bracket 3, reduces the overall weight of the safety seat. The first sliding stopper and the second sliding stopper serve as the seat back recline guide and the seat base recline guide, respectively, overcoming the difficulties encountered when using a single bracket for adjusting the pitch angle of the seat unit. This facilitates handling and installation, and reduces the production cost of the safety seat. 4 , the first sliding limit mechanism includes a guide slide 321 arranged transversely on the second connecting member 32 , and two sets of symmetrical and spaced apart slide grooves 221 arranged on the rear side of the seat back 22 .

The length directions of the two sets of slide grooves 221 are perpendicular to the length direction of the guide slide 321, and the two end portions of the guide slide 321 extend into the two sets of slide grooves 221 and slideably engage with the two sets of slide grooves 221 , respectively. The sliding engagement between the two sets of slide grooves 221 and the guide slide bar 321 allows the seat back 22 to slide back and forth along the length of the second connecting member 32.

The symmetrical arrangement of the slide grooves 221 ensures that the guide slide bars 321 on both sides of the second connecting member 32 are of equal length during the sliding process of the seat back 22, preventing the seat back 22 from tipping over. This improves the safety of children when using the seat back 22 and protects the guide slide bar 321. It also enables the use of a single bracket to adjust the pitch angle of the seat unit 2, making it easier for users to adjust the reclining angle. The two ends of the guide slide bar 321 of this embodiment extend into the two sets of slide grooves 221 and abut against the bottom of the slide grooves 221.

The slide grooves 221 limit the circumferential rotational movement of the guide slide bar 321 relative to the seat back 22, thereby limiting the circumferential rotational movement of the seat unit 2 relative to the bracket 3, further increasing the stability of the seat unit 2 during rotation.

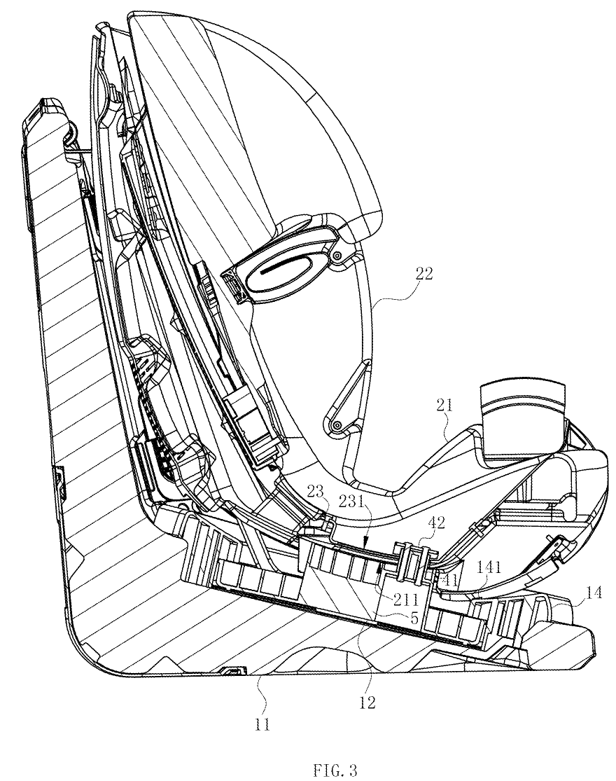

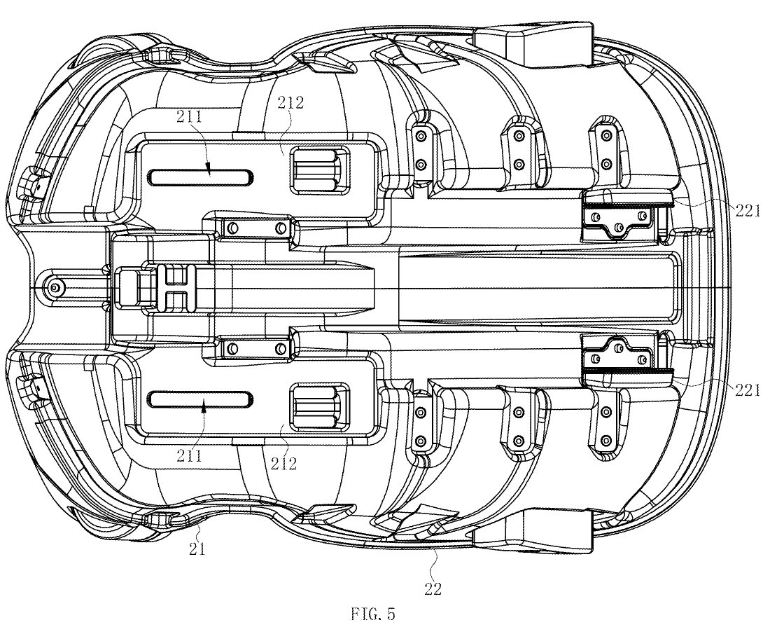

Referring to FIGS. 3 and 5 , the second sliding stop mechanism comprises two sets of symmetrically spaced guide sliders 4 on the base unit 1, and two symmetrically spaced slide holes 211 extending through the seat base 21.

The slide holes 211 are arranged in an arc shape along the fore-aft direction of the seat base 21. The two sets of guide sliders 4 are respectively slidably stopped within the two sets of slide holes 211 and slidably engage with them. The slidable engagement between the slide holes 211 on the seat base 21 and the guide sliders 4 on the base unit 1 prevents the bracket 3 from bearing the weight of the seat base 21.

Simultaneously, the weight of the seat base 21 is applied to the guide sliders 4 symmetrically distributed on the base unit 1, resulting in balanced forces on both sides of the seat base, preventing tilt. This stabilizes the center of gravity of the seat base 21, further enhancing the stability of the single bracket when adjusting the pitch angle of the seat unit 2, and facilitating forward tilt adjustment.

The guide slider 4 includes a sliding pin 41 and a limit block 42 connected to the sliding pin 41, wherein the sliding pin 41 is vertically inserted into the sliding hole 211 and slides with the inner wall of the sliding hole 211; the limit block 42 has a width greater than the width of the sliding hole 211 and is disposed outside the sliding hole 211 to limit the upward movement of the seat unit 2 relative to the base 11.

The seat unit 2 also includes a guide rail member 23 positioned at the upper opening of the slide hole 211. The upper surface of the guide rail member 23 slidably engages the lower surface of the stop block 42. A first through-hole 231 is formed through the guide rail member 23 for the slide pin 41 to pass through. The first through-hole 231 communicates with the slide hole 211. The slide pin 41 passes through the slide hole 211 and the first through-hole 231, sequentially from bottom to top, and is fixedly connected to the stop block 42 at its upper end. During tilt adjustment, the stop block 42 slides along the upper surface of the guide rail member 23, assisting in the sliding motion and ensuring smoother movement of the guide slider 4 within the slide hole 211.

Referring to FIGS. 3 and 5, the lower surface of the seat base 21 is partially recessed to form a sliding portion 212. The surface of the sliding portion 212 matches the shape of the upper surface of the shift rail 5 and is capable of sliding back and forth along the upper surface of the shift rail 5. The sliding engagement between the sliding portion 212 and the shift rail 5 acts as a guide, increasing the stability of the seat unit 2 during pitch angle adjustment.

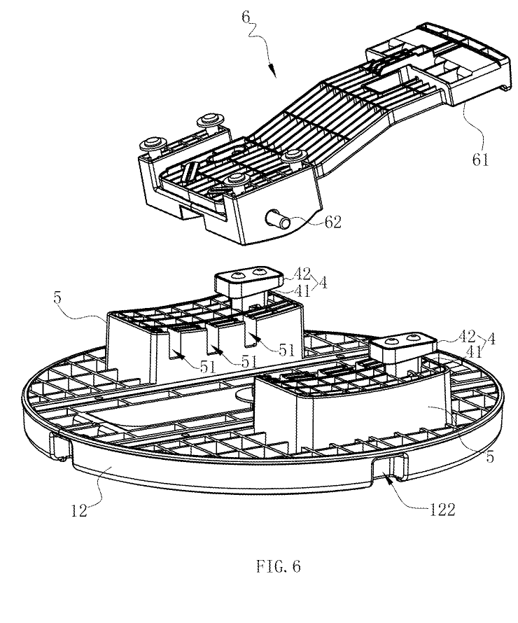

Referring to FIG. 6, the posture adjustment mechanism includes two sets of symmetrically spaced shift rails 5 disposed on the base unit 1, and a corresponding shift adjustment mechanism 6 connected to the seat base 21. The shift rails 5 are provided with shift slots 51 spaced apart along the front-to-back direction of the seat base 21.

The shift adjustment mechanism 6 includes an actuating member 61 for applying external force and a shift lever 62 that engages with the actuating member 61. The shift lever 62 is disposed between the two sets of shift rails 5, with both ends of the shift lever 62 mating with the two sets of shift slots 51. The rod 62 can be engaged and disengaged from any corresponding set of shift slots 51. When the operating member 61 drives the shift rod 62 out of the most corresponding shift slot 51, the seat unit 2 can adjust its pitch angle relative to the base unit 1 through the sliding cooperation of the first and second slide stop mechanisms.

When the operating member 61 drives the shift rod 62 into the most corresponding shift slot 51, the pitch angle of the seat unit 2 relative to the base unit 1 is locked. The shift rail 5 provided on the base unit 1 allows the weight of the seat unit 2 to be supported by the shift rail 5 rather than directly applied to the bracket 3, further reducing the pressure on the bracket 3.

The user can pull the operating member 61 to disengage the shift rod 62 from the shift slot 51, allowing the seat unit 2 to slide relative to the bracket 3. When the shift rod 62 is released, it reengages the shift slot 51. Furthermore, to enhance child comfort, the seat unit 2 needs to be adjustable in various orientations.

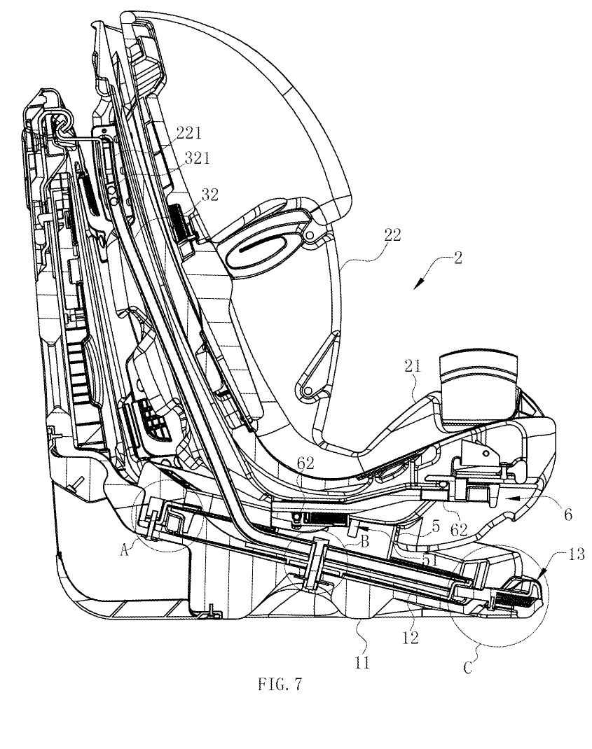

Referring to FIG. 7 , the base unit 1 includes a base 11, a rotating disk 12 rotatably connected to the base 11, and a rotational stop assembly 13 disposed on the base 11. The seat unit 2 is mounted on the rotating disk 12, and the rotational stop assembly 13 acts on the rotating disk 12 to limit its rotational position. The rotating disk 12 allows the seat unit 2 to be rotated relative to the base 11. When adjusted to the appropriate angle, the rotational stop assembly 13 holds the rotating disk 12 in that rotational position.

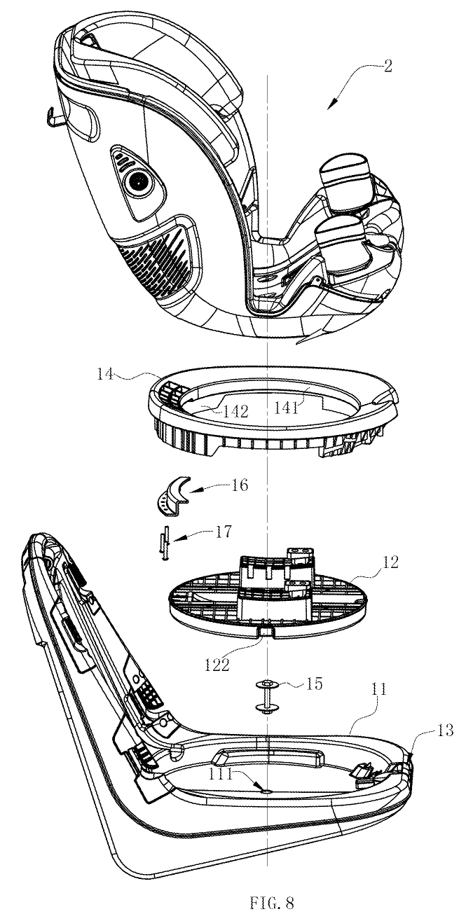

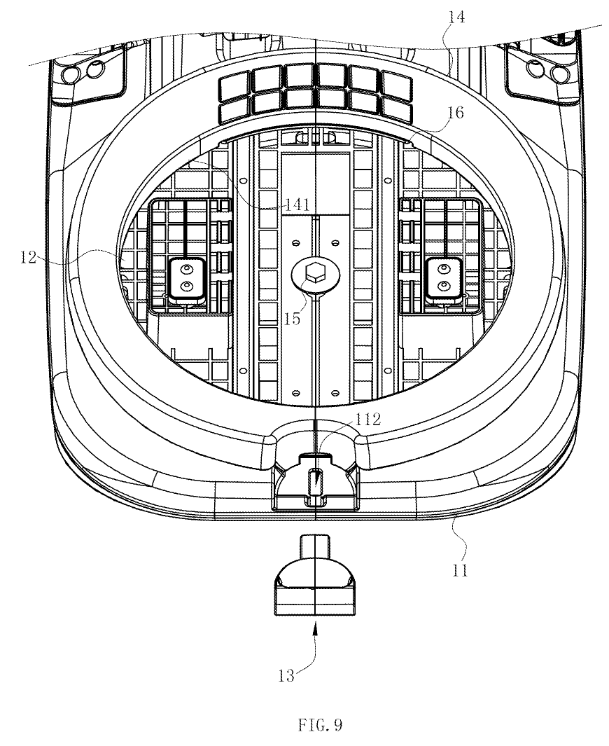

Referring to FIGS. 8 and 9, the base unit 1 also includes an annular stopper ring 14 fixedly connected to the base 11. The rotating disk 12 is disposed between the stopper ring 14 and the base 11. The stopper ring 14 has a stopper portion 141 formed thereon, which cooperates with the rotating disk 12 to limit its axial position. The stopper 141 of the stopper ring 14 restricts the axial outward movement of the rotating disc 12, preventing the rotating disc 12 from becoming detached from the base 11 due to changes in the center of gravity of the seat unit 2 during rotation, potentially causing a dangerous situation.

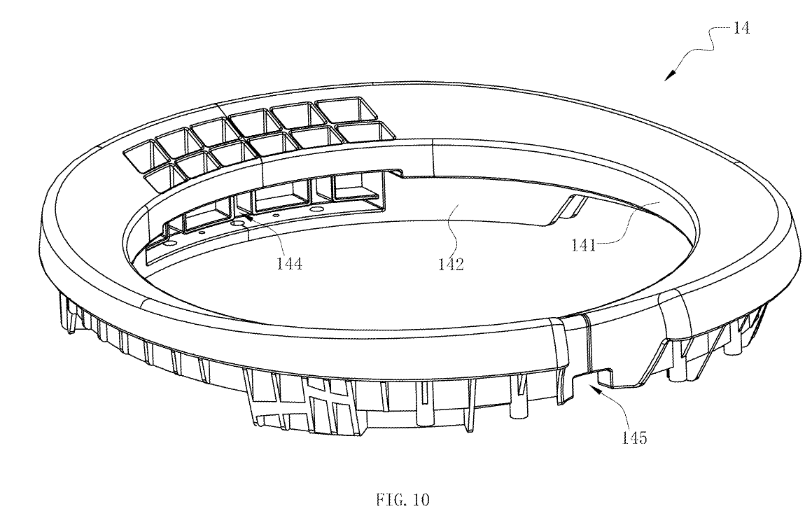

Referring to FIG. 10, the stopper 141 is a stepped surface formed by a circumferential protrusion on the inner wall of the stopper ring 14. Below the stopper 141, the inner wall of the stopper ring 14 has a recessed portion 142 that is concave inward relative to the stopper 141. The outer edge of the rotating disc 12 abuts against the stepped surface below and aligned with the stopper 141. A gap 143 is also left between the outer edge of the rotating disc 12 and the recessed portion 142, allowing the rotating disc 12 to rotate.

This gap 143 prevents friction between the rotating disc 12 and the stopper ring 14 during rotation, ensuring smooth rotation and effortless adjustment, making it easier for the user to adjust the seat unit 2.

Referring to FIGS. 8 and 9, a baffle 16 is provided between the rotating disk 12 and the limiting pressure ring 14. This baffle 16 has a greater structural strength than the limiting pressure ring 14 and is located inside the inner wall of the limiting pressure ring 14. This location prevents direct friction between the rotating disk 12 and the limiting pressure ring 14 and prevents direct impact from the rotating disk 12 on the limiting pressure ring 14.

This extends the service life of the limiting pressure ring 14 while enhancing its impact resistance. 9 to 12, a baffle groove 144 is formed on the recessed portion 142 of the limiting pressure ring 14 for installing the baffle 16. The baffle 16 is arranged in the baffle groove 144. The baffle 16 includes a connecting portion 161 and an L-shaped bent portion 162.

The connecting portion 161 is provided with a connecting hole 1611. The limiting pressure ring 14 is provided on the base 11 through a fastener 17. The fastener 17 passes through the connecting hole 1611 on the connecting portion 161 and connects the baffle 16 to the limiting pressure ring 14, thereby improving the stability of the connection between the baffle 16 and the limiting pressure ring 14. The L-shaped bent portion 162 is connected to one side of the connecting portion 161, and the top of the L-shaped bent portion 162 is against the lower surface of the limiting portion 141. The L-shaped bend 162 blocks axial impacts of the rotating disk 12 against the stopper 141, thereby protecting the stopper 141 and enhancing its impact resistance.

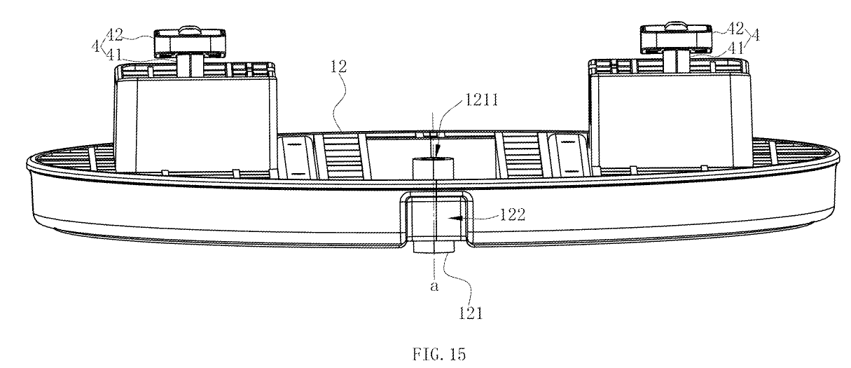

Referring to FIGS. 8 and 15, the base 11 is provided with a through-hole 111. A rotating shaft 121 protrudes axially from the center of the rotating disk 12. The rotating shaft 121 fits within and extends through the through-hole 111. The rotating disk 12 is rotatably connected to the base 11 via the rotating shaft 121. The central axis of the rotating shaft 121 is designated as the rotation axis a. The rotational connection between the rotating shaft 121 and the through-hole 111 enables the rotating disk 12 to rotate stably about the rotation axis a, thereby enhancing its rotational stability.

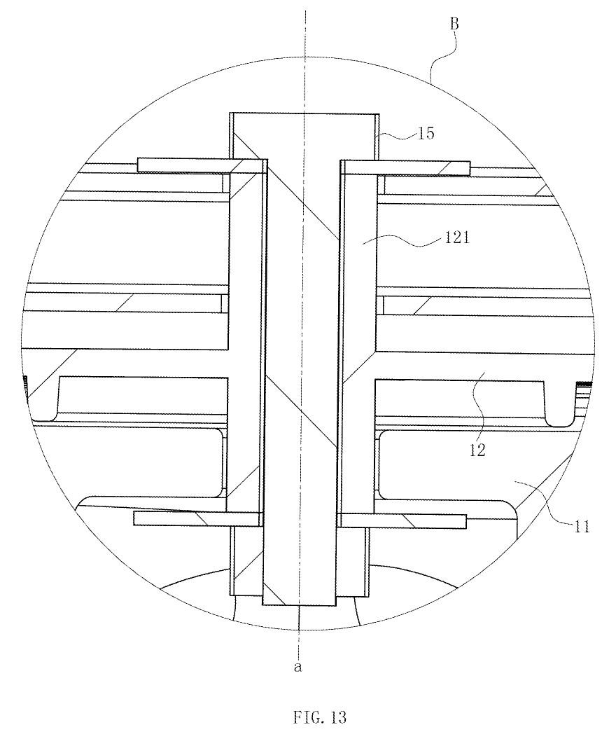

Referring to FIGS. 13 and 15, a mounting hole 1211 is axially extending through the rotating shaft 121. A connector 15 is provided between the rotating shaft 121 and the base 11. The connector 15 extends axially through the mounting hole 1211 to axially limit the connection between the rotating shaft 121 and the base 11. The provision of the connector 15 prevents axial separation between the rotating disk 12 and the base 11, thereby increasing the stability of the connection between the rotating disk 12 and the base 11 and improving the safety of children. 9 , 10 , 14 , 15 and 16 , a slot 122 is provided inwardly on the outer edge of the rotating disk 12 in a partially circumferential direction, and four slots are evenly spaced around the circumference of the rotating disk 12.

The rotation limit assembly 13 includes a latch 131 and a compression spring 132, wherein the latch 131 is slidably arranged on the base 11 along the radial direction of the rotating disk 12, and a latch 1311 is provided on the latch 131. A handle 1312 exposed on the outer surface of the base 11 is provided on the latch 131, and the latch 131 is adapted to and arranged relative to the slot 122. The limiting pressure ring 14 is provided with a notch 145 for the latch 1311 to penetrate the slot 122; the compression spring 132 is provided between the base 11 and the latch 131, and has a tendency to radially press the latch 131 radially inwardly along the radial direction of the rotating disk 12.

The user can unlock the rotational position of the rotating disk 12 by applying radial force to the latch 131. Alternatively, releasing the latch 131 causes the compression spring 132 to rebound, pushing the latch 131 back to its original position and relocking the rotating disk 12, making it easy for the user to adjust the rotational position of the rotating disk 12 multiple times. The base 11 is provided with radially distributed sliding holes 112. The latch 131 partially protrudes downward and is connected to a sliding member 133. The sliding member 133 slidably engages with the sliding hole 112, facilitating radial reciprocating movement of the latch 131.

Referring to FIG. 7, the first connecting member 31 is fixedly connected to the surface of the rotating disk 12, while the second connecting member 32 is connected to the seat back 22 to support it. Part or all of the second connecting member 32 is embedded within the seat back 22 to support it. The first connector 31 is fixedly connected to the surface of the rotating disk 12, allowing the bracket 3 to rotate synchronously with the rotating disk 12 and the seat unit 2. During rotation, the relative position of the bracket 3 and the seat unit 2 remains unchanged. This allows the second connector 32 to continuously support the seat back 22 during rotation, preventing the seat unit 2 from tilting backward.

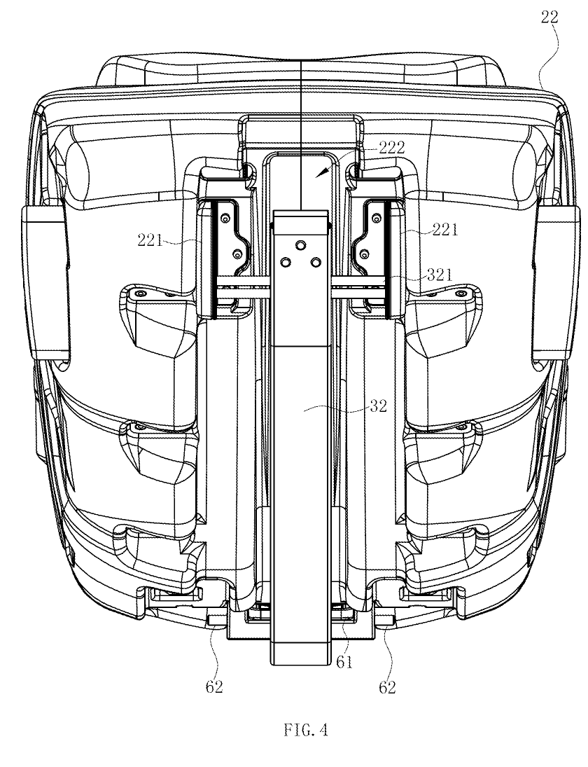

Referring to FIGS. 4 and 7, the rear side of the seat back 22 is provided with a recessed groove 222 for the second connector 32 to fit into. The bottom of the recess 222 contacts the second connector 32. The provision of the locking groove 222 facilitates manufacturer-specific positioning and installation of the bracket 3. The bottom of the locking groove 222 contacts the second connector 32, allowing the bracket 3 to withstand the rearward pressure of the seat back 22 and the child.

Furthermore, the second connector 32, nested within the locking groove 222, limits the circumferential rotational movement of the seat back 22 relative to the second connector 32, allowing the seat unit 2 to remain stationary relative to the bracket 3 during rotation. This ensures that the bracket 3 consistently supports the seat back 22 during rotational adjustment, further enhancing the stability of the seat unit 2 during rotation.

The inclination angle of the second connector 32 is the same as that of the seat back 22. This technical solution ensures that the second connector 32 and the seat back 22 are arranged parallel to each other, preventing interference during assembly and rotation that could cause wear on the seat back 22, thereby extending the service life of the seat back 22. The rear side of the seat back 22 is provided with a sliding groove 221 arranged in a forward and backward direction.

The second connector 32 is equipped with a connecting rod 43 that slidably engages with the sliding groove 221. The coupling of the connecting rod 43 and the slide slot 221 allows the seat back 22 to be tilted relative to the bracket 3. Furthermore, the mating surface between the connecting rod 43 and the slide slot 221 distributes the backward pressure of the seat back 22 and the child during the sliding process, further enhancing stability and facilitating the user's pitch adjustment of the seat unit 2.

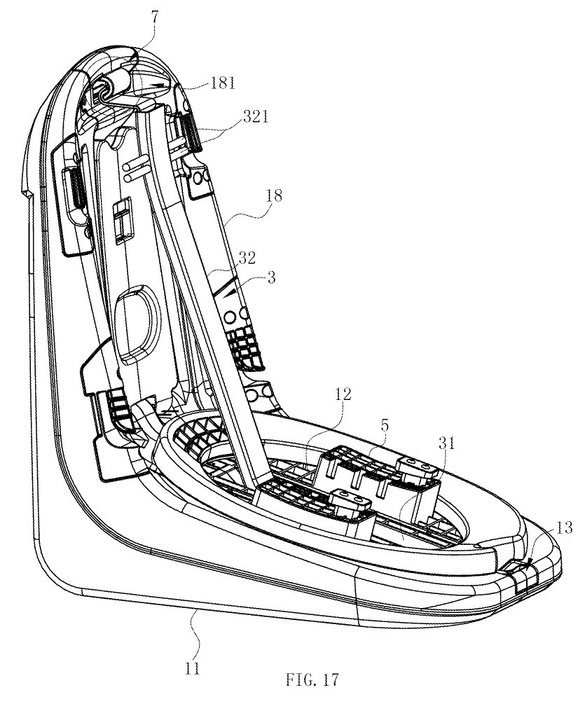

Referring to FIG. 17, the base 11 is an L-shaped base with a base back 18. A connecting structure 7 is provided between the second connecting member 32 and the front side of the base back 18. The provision of the connecting structure 7 strengthens the connection between the base 11 and the second connecting member 32, allowing the base back 18 to distribute the pressure exerted on the second connecting member 32.

Furthermore, because the second connecting member 32 is connected to the seat back 22, the connecting structure 7 also indirectly connects the base back 18 to the seat back 22, preventing the base 11 from separating from the seat unit 2 due to the seat unit 2 tilting forward in certain positions. This also enhances the load-bearing capacity of the bracket 3 and improves the safety of the child, providing a "two-in-one" advantage.

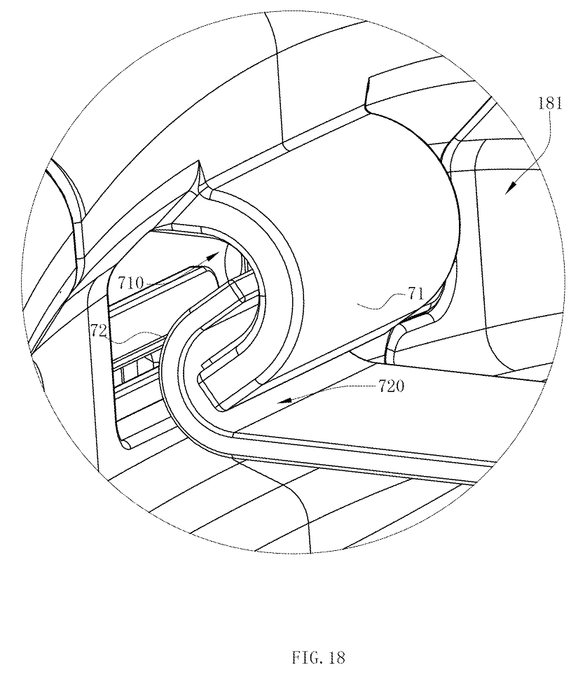

Referring to FIG. 18, the connecting structure 7 includes a first connecting hook 71 and a second connecting hook 72. The first connecting hook 71 is fixedly mounted on the front side of the base backrest 18, while the second connecting hook 72 is fixedly mounted on the upper end of the second connecting member 32. The first connecting hook 71 is connected to the first connecting hook 71 in a fore-aft limit position and is movable relative to the first connecting hook 71 along the rotational direction of the rotating disk 12. This allows the first connecting hook 71 and the second connecting hook 72 to disengage from each other when the bracket 3 rotates relative to the base 11. When the seat unit 2 is facing forward, the first and second connecting hooks 71 and 72 are connected in a fore-aft limit position to prevent forward tilting.

However, when the seat unit 2 rotates relative to the base 11, the first and second connecting hooks 71 and 72 disengage from each other, allowing the rotational movement of the seat unit 2 to be unrestricted by the connecting structure 7. This allows the connecting structure 7 to accommodate the rotational movement of the seat unit 2 relative to the base 11. The first connecting hook 71 has two through-slots 710 formed on either side perpendicular to the rotational direction, allowing the second connecting hook 72 to rotate out of the way. The second connecting hook 72 also has two through-slots 720 formed on either side perpendicular to the rotational direction, allowing the first connecting hook 71 to rotate out of the way. A relief groove 181 is recessed on the front side of the base backrest 18, corresponding to the second connecting hook 72. This relief groove 181 is designed to prevent rotational movement of the second connecting hook 72 relative to the base 11. The design of the relief groove 181 prevents interference between the second connecting hook 72 and the base backrest 18 during rotational adjustment, facilitating user adjustment of the seat unit 2.

This embodiment of the child safety seat can achieve the following functions: 1) Rotational Adjustment: The user pulls the handle 1312 forward, disengaging the latch 1311 from the slot 122. This compresses the compression spring 132, and the user applies force to the seat unit 2 to rotate it, disengaging the first connecting hook 71 from the second connecting hook 72. After the user rotates the seat unit 2 to the appropriate angle, they release the handle 1312, causing the latch 1311 to reengage the slot 122, completing the rotational adjustment. During rotation, the seat unit 2 and the bracket 3 rotate synchronously, ensuring that the bracket 3 always supports the seat back 22, preventing the seat unit 2 from tilting outward during rotation. 2) Pitch angle adjustment: the user pulls the action member 61 forward, and the shift lever 62 disengages from the shift slot 51, allowing the seat unit 2 to slide relative to the bracket 3. The user then keeps the action member 61 pulled forward and simultaneously pulls or pushes the seat unit 2 and the action member 61 forward or backward to adjust the pitch angle. During the adjustment process, the slide slot 211 slides along the guide slide bar 321, causing the rearward tilt angle of the seat back 22 to change, and the guide slider 4 slides along the guide rail member 32 and the slide hole 211, causing the forward tilt angle of the seat base 21 to change; after sliding to the appropriate angle, the user releases the action member 61, and the shift lever 62 re-engages the shift slot 51, completing the pitch angle adjustment; during this adjustment process, the bracket 3 only The second connector 32 withstands pressure from the seat back 22 and the child's back, while pressure from the seat base 21 and the area below the child's buttocks is transferred to the base 11 via the shift rail 5.

This reduces the pressure on the bracket 3 and extends the life of the child safety seat. Furthermore, because the bracket 3 bears less weight, the pitch angle adjustment of the child safety seat in this embodiment can be designed as a single bracket. The symmetrical arrangement of the slide groove 221, guide slider 4, shift rail 5, guide rail member 23, slide hole 211, and sliding portion 212 ensures the stability of the seat unit 2 during pitch angle adjustment, preventing the seat unit 2 from tilting to one side after the shift lever 62 disengages from the shift slot 51.

1. A child safety seat, comprising:
a base unit (1);
a seat unit (2), movably disposed on the base unit (1), comprising:
a seat base (21) and a seat back (22) connected to the rear side of the seat base (21);
a posture adjustment mechanism, disposed between the seat unit (2) and the base unit (1), for adjusting the pitch angle of the seat unit (2) relative to the base unit (1); characterized in that it further comprises a bracket (3), the bracket (3) comprising a first connecting member (31) connected to the base unit (1), and a bracket (31) connected to the rear side of the first connecting member (31) and extending obliquely upward, a second connecting member (32) is provided between the second connecting member (32) and the seat back (22), and a second sliding limiting mechanism is provided between the base unit (1) and the seat base (21); when the pitch angle of the seat unit (2) relative to the base unit (1) is adjusted by the posture adjustment mechanism, the first sliding limiting mechanism can cause the seat back (22) to slide relative to the second connecting member (32) in the longitudinal direction of the seat back (22), and the second sliding limiting mechanism can cause the seat base (21) to slide on the base unit (1) in the front-rear direction of the seat base (21).

2. The child safety seat according to claim 1, characterized in that the first sliding limit mechanism comprises: a guide slide bar (321) disposed on the second connecting member (32), the guide slide bar (321) being disposed transversely; two sets of symmetrical and spaced apart slide grooves (221) disposed on the rear side of the seat back (22), the length directions of the two sets of slide grooves (221) being perpendicular to the length direction of the guide slide bar (321), and the two ends of the guide slide bar (321) respectively extending into the two sets of slide grooves (221) and slidingly engaging with the two sets of slide grooves (221).

3. The child safety seat according to claim 1, characterized in that the second sliding limit mechanism comprises: Two sets of guide sliders (4) arranged symmetrically and spaced apart on the base unit (1); two slide holes (211) arranged symmetrically and spaced apart are provided on the seat base (21); the slide holes (211) are distributed in an arc shape along the front-back direction of the seat base (21); the two sets of guide sliders (4) are respectively slidably limited in the two sets of slide holes (211) and slideably engage with the two sets of slide holes (211).

4. The child safety seat according to claim 3, characterized in that the guide slider (4) comprises: A sliding pin (41) vertically inserted into the slide hole (211) and slideably engages with the inner wall of the slide hole (211); A limit block (42) connected to the sliding pin (41); the width of the limit block (42) is greater than the width of the slide hole (211) and is disposed outside the slide hole (211) to limit the upward movement of the seat unit (2) relative to the base (11).

5. The child safety seat according to claim 4, characterized in that the seat unit (2) further comprises a guide rail member (23) provided at the upper opening of the sliding hole (211), the upper surface of the guide rail member (23) slidingly cooperates with the lower surface of the limit block (42), the guide rail member (23) is penetrated by a first through hole (231) for the sliding pin (41) to pass through, the first through hole (231) is connected to the sliding hole (211), the sliding pin (41) passes through the sliding hole (211) and the first through hole (231) from bottom to top in sequence, and is fixedly connected to the limit block (42) at the upper end.

6. The child safety seat according to claim 1, characterized in that the posture adjustment mechanism comprises: two sets of symmetrically spaced shift rails (5) arranged on the base unit (1), the shift rails (5) being provided with shift slots (51) spaced along the front-to-rear direction of the seat base (21), and correspondingly, a shift adjustment mechanism (6) being connected to the seat base (21), the shift adjustment mechanism (6) comprising an action member (61) for applying an external force and a shift lever (62) in transmission engagement with the action member (61), the shift lever (62) being provided between the two sets of shift rails (5), and the two ends of the shift lever (62) being in contact with the seat base (21). The shift lever (62) is adapted to correspond to two groups of shift slots (51), and can be inserted into any group of corresponding shift slots (51) and can also be disengaged from the group of shift slots (51); when the operating member (61) drives the shift lever (62) to disengage from a certain corresponding shift slot (51), the seat unit (2) can adjust its own pitch angle relative to the base unit (1) under the sliding cooperation of the first sliding limit mechanism and the second sliding limit mechanism; when the operating member (61) drives the shift lever (62) to insert into a certain corresponding shift slot (51), the pitch angle of the seat unit (2) relative to the base unit (1) is locked.

7. The child safety seat according to claim 6, characterized in that: the lower surface of the seat base (21) is partially recessed inward to form a sliding portion (212), the surface of the sliding portion (212) is adapted to the shape of the upper surface of the shift rail (5) and can slide back and forth along the upper surface of the shift rail (5).

8. The child safety seat according to claim 1, characterized in that: the base unit (1) includes a base (11), a rotating disk (12) rotatably connected to the base (11), and a rotation limiting assembly (13) provided on the base (11); the seat unit (2) is provided on the rotating disk (12); the rotation limiting assembly (13) can act on the rotating disk (12) to thereby limit the rotational position of the rotating disk (12).

9. The child safety seat according to claim 8, characterized in that: the first connecting member (31) is fixedly connected to the surface of the rotating disk (12); the second connecting member (32) is connected to the seat back (22) to support the seat back (22); part or all of the second connecting member (32) is embedded in the seat back (22) to support the seat back (22).

10. The child safety seat according to claim 8, characterized in that: the base unit (1) further comprises a ring-shaped limiting pressure ring (14) fixedly connected to the base (11); the rotating disk (12) is disposed between the limiting pressure ring (14) and the base (11); and a limiting portion (141) is formed on the limiting pressure ring (14), and the limiting portion (141) can cooperate with the rotating disk (12) to achieve axial limiting of the rotating disk (12).
